(19) United States
(12) Patent Application Publication
(10) Pub. No.: US 2007/0139295 A1
(43) Pub. Date: Jun. 21, 2007

(54) Extra-monitor control circuit system for monitor

(76) Inventor: Heng Chun Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/312,742

(22) Filed: Dec. 21, 2005

(51) Int. Cl. G09G 5/00

(52) U.S. Cl. 345/1.1

(57) ABSTRACT

An extra-monitor control circuit system for monitor includes one or more of an OSD circuit, a scaler circuit, and an A/D converting circuit, and a DC/DC converting circuit. The extra-monitor control circuit system is located at a position outside a monitor, and the DC/DC converting circuit converts power supplied from a power supply of a PC host and supplies the converted power to the monitor. The extra-monitor control circuit system may be in the form of an independent unit adapted to insert into an expansion slot on the PC host, or integrated into a PC graphic card. With the extra-monitor control circuit system, the monitor can be manufactured at a reduced cost and the problems of signal distortion and compatibility can be avoided.

### FIELD OF THE INVENTION

The present invention relates to an extra-monitor control circuit system for a monitor, and more particularly to an extra-monitor control circuit system that includes one or more of an On Screen Display (OSD) circuit, a scaler circuit, and an analog-to-digital (A/D) converting circuit, and a DC/DC converting circuit, and is located at a position outside the monitor. The extra-monitor control circuit system may be in the form of an independent unit, or integrated into a personal computer (PC) graphic card. The DC/DC converting circuit in the control circuit system substitutes for the conventional AC converting circuit in the monitor to supply from a PC host the power needed by the monitor. The extra-monitor control circuit system enables reduced costs for manufacturing the monitor and the control circuit, avoids the problems of signal distortion and compatibility.

### BACKGROUND OF THE INVENTION

Generally, circuits inside a liquid-crystal display (LCD) monitor are divided into an LCD control module and an LCD panel module. The LCD control module is mainly used to communicate a PC host with the LCD panel module. FIG. 1 shows various control circuits included in the control module when a digital transmission of signal is adopted. As shown, the PC host end has a graphic card 1 internally provided with a main circuit 11 and a video graphics array (VGA) circuit 12, and the monitor 2 is internally provided with a control module consisting of an OSD circuit 21, a scaler circuit 22, and a low voltage differential signal (LVDS) circuit 24. One or two signal cables 3 and connectors 31 thereof are provided between the PC graphic card 1 and the monitor 2 for transmitting digital signals. And, FIG. 2 shows various control circuits included in the control module when an analog transmission of signal is adopted. As shown, the PC graphic card 1 is internally provided with a main circuit 11, a VGA circuit 12, and a D/A converting circuit 13; and the monitor 2 is internally provided with an OSD circuit 21, a scaler circuit 22, a LVDS circuit 24, and an A/D converting circuit 23. One or two signal cables 3 and connectors 31 thereof are provided between the PC graphic card 1 and the monitor 2 for transmitting analog signals.

Power needed by the monitor 2 is supplied via an independent power cable, which is connected at an end to a city power source and at the other end to an AC converting circuit 5 inside the monitor 2.

The AC converting circuit 5 and the control module circuits provided inside the monitor 2 require high manufacturing costs to thereby increase the overall manufacturing cost of the monitor 2. And, the signals tend to become distorted after D/A and A/D conversions, and have the problem of poor compatibility with various circuits. Moreover, since the power supplied to the monitor 2 must be converted via a separate AC converting circuit 5, the AC converting circuit 5 forms additional cost of the monitor 2 to reduce the competition ability of the monitor in the market.

### SUMMARY OF THE INVENTION

A primary object of the present invention is to provide an extra-monitor control circuit system for monitor, in which one or more of an OSD circuit, an A/D converting circuit, and a scaler circuit, which are conventionally provided inside the monitor, together with a DC/DC converting circuit are included to locate at a position outside the monitor. The DC/DC converting circuit converts power supplied from a power supply on a PC host for supplying to the monitor, enabling large reduction of the overall manufacturing cost of the monitor and avoiding the problems of signal distortion and compatibility to upgrade the quality and increase the competition ability of the monitor in the market.

The extra-monitor control circuit system of the present invention may be in the form of an independent unit adapted to insert into an expansion slot on a PC host.

Alternatively, the extra-monitor control circuit system of the present invention may be integrated into a PC graphic card.

The DC/DC converting circuit converts power supplied from a power supply of a PC host for supplying to the monitor, and replaces the AC converting circuit conventionally provided in the monitor.

The extra-monitor control circuit system of the present invention is electrically connected to the monitor via one or more cables and connectors thereof for transmitting signals and power from the PC host to the monitor.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional control circuit inside a monitor for digital transmission of signals from a PC host to the monitor;

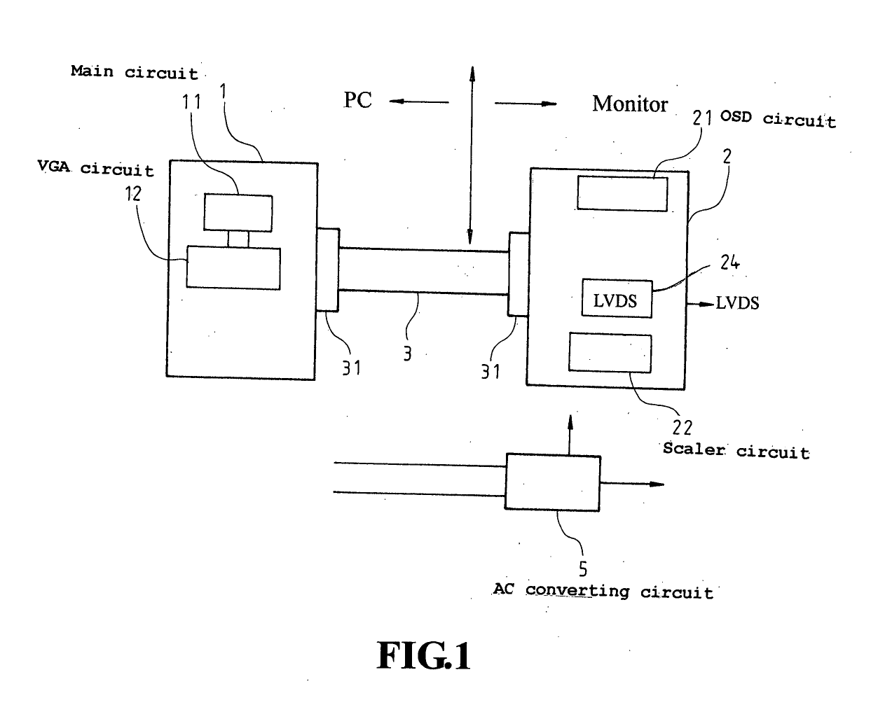

FIG. 2 is a block diagram of a conventional control circuit inside a monitor for analog transmission of signals from a PC host to the monitor;

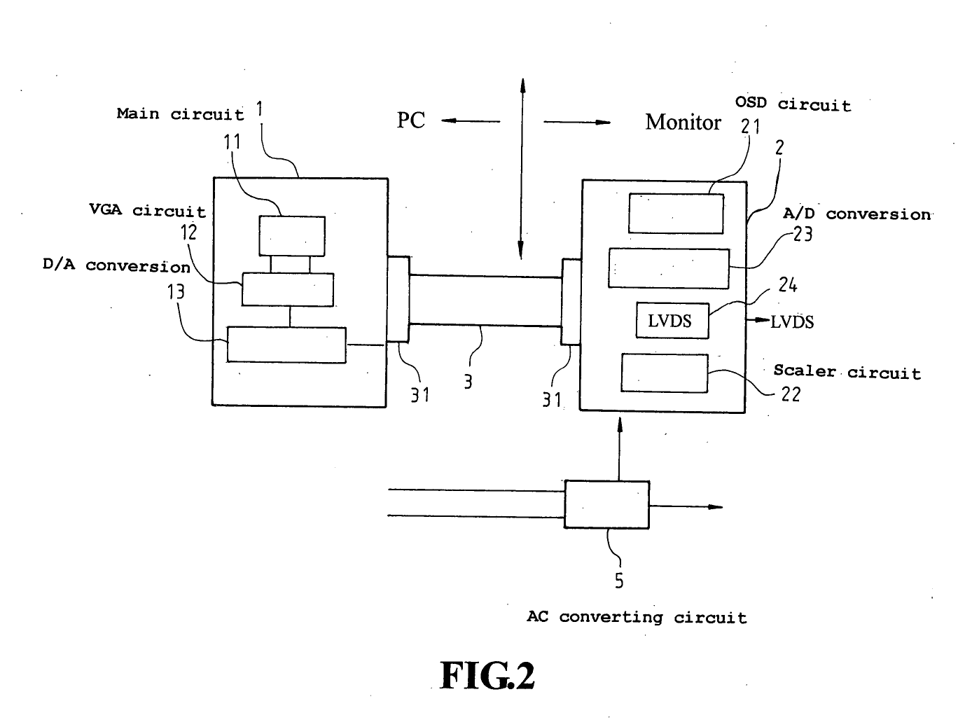

FIG. 3 is a block diagram of an extra-monitor control circuit system for a monitor according to a first embodiment of the present invention;

FIG. 4 is a block diagram of an extra-monitor control circuit system for a monitor according to a second embodiment of the present invention; and

FIG. 5 is a block diagram of an extra-monitor control circuit system for a monitor according to a third embodiment of the present invention.

### DETAILED DESCRIPTION OF THE PREFERRED EMBODIMENTS

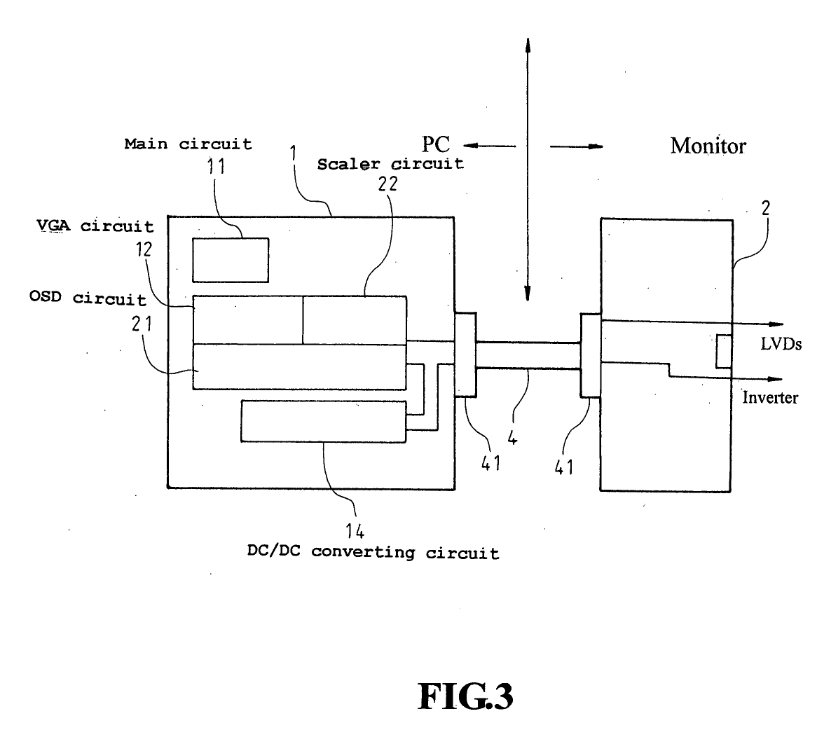

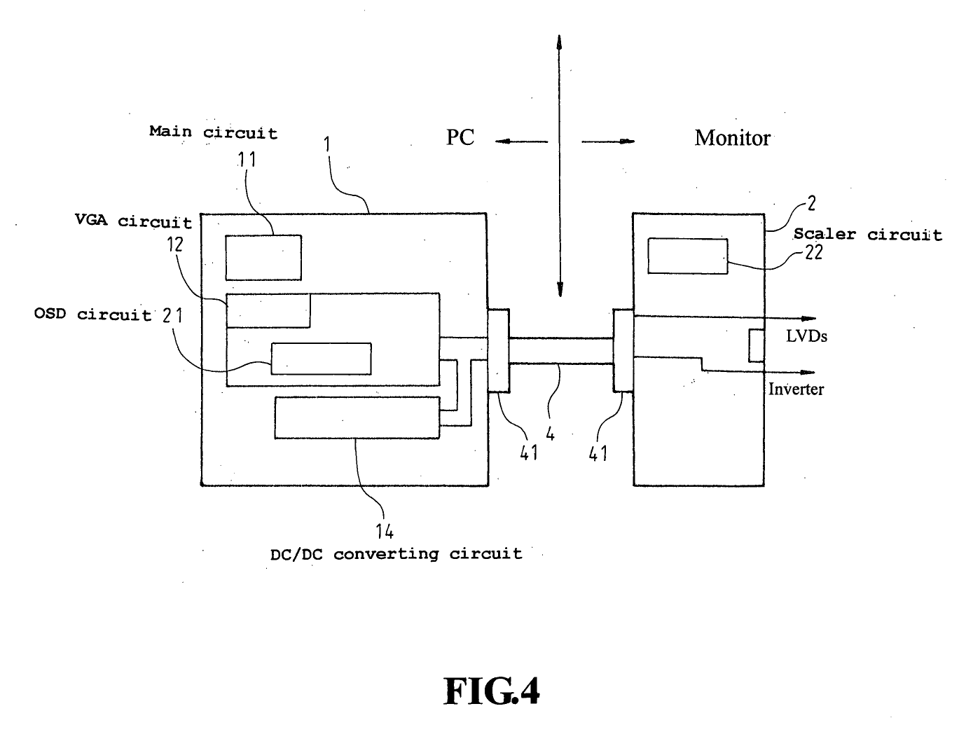

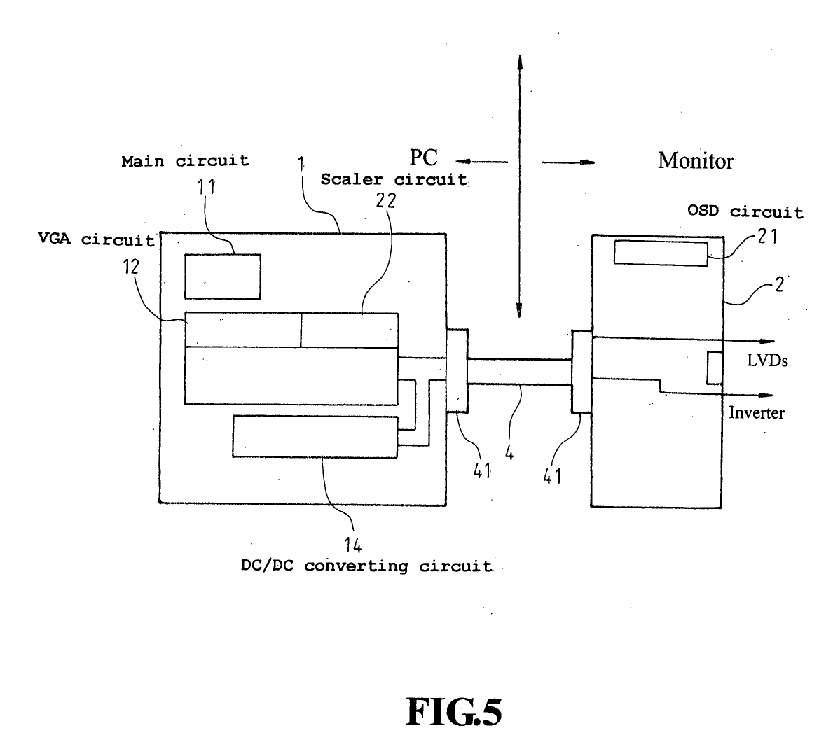

Please refer to FIGS. 3, 4, and 5 that are block diagrams of an extra-monitor control circuit system for a monitor according to a first, a second, and a third embodiment of the present invention, respectively. As shown, the extra-monitor control circuit system for monitor according to the present invention includes one or more of an OSD circuit 21, a scaler circuit 22, and an A/D converting circuit 23, and a DC/DC converting circuit 14, and is located at a position outside a monitor 2. The extra-monitor control circuit system may be in the form of an independent unit or be integrated into a PC graphic card 1.

When the extra-monitor control circuit system is in the form of an independent unit, it may be manufactured into, for example, an independent control circuit card for conveniently inserting into an expansion slot on a PC host, so as to control the monitor 2 and supply power to the monitor 2 from the PC host.

When the extra-monitor control circuit system is integrated into a PC graphic card 1, the circuits conventionally provided in the PC graphic card 1, the OSD circuit 21, the scaler circuit 22, and/or the A/D converting circuit 23, and the DC/DC converting circuit 14 are manufactured at the same time to form an integral unit for controlling the monitor 2 and supplying power to the monitor 2 from the PC host.

The extra-monitor control circuit system for monitor of the present invention utilizes power supplied from a power supply of a PC host. The DC/DC converting circuit 14 in the extra-monitor control circuit system converts the power from the PC host power supply and directly supplies the converted power to the monitor 2, so that the separate AC converting circuit conventionally provided in the monitor 2 is omitted to reduce the manufacturing cost of the monitor 2.

The extra-monitor control circuit system of the present invention is electrically connected to the monitor 2 via one or more cables 4 and connectors 41 thereof to transmit signals and power from the PC host to the monitor 2.

The present invention has at least the following advantages:
1. It is easier and more economical to provide the monitor control circuits outside the monitor in the form of an independent unit or to integrate the monitor control circuits into a PC graphic card. Therefore, the extra-monitor control circuit system of the present invention largely simplifies the technique and process and reduces the time and cost for manufacturing a monitor and the control circuits thereof.
2. Since the conventional D/A and A/D conversions are simplified through the use of the extra-monitor control circuit system, signal distortion may be avoided.
3. The problems of incompatibility of circuits, elements, or systems with one another are avoided.
4. The power needed by the monitor is supplied from the PC host power supply and converted by the DC/DC converting circuit. The conventional AC converting circuit provided in the monitor is omitted to save the cost thereof.
5. With the extra-monitor control circuit system, the number of cables needed for transmitting signals and power from the PC host to the monitor is reduced from at least two or three cables to even only one cable for transmitting both signals and power to thereby create the highest possible profit.

What is claimed is:

1. An extra-monitor control circuit system for monitor, comprising one or more of an OSD circuit, a scaler circuit, and an A/D converting circuit, and a DC/DC converting circuit; said extra-monitor control circuit system being located at a position outside a monitor, and said DC/DC converting circuit converting power supplied from a power supply of a PC host and supplying the converted power to said monitor.

2. The extra-monitor control circuit system for monitor as claimed in claim 1, wherein said one or more of said OSD circuit, said scaler circuit, and said A/D converting circuit, and said DC/DC converting circuit are in the form of an independent unit adapted to insert into an expansion slot on said PC host.

3. The extra-monitor control circuit system for monitor as claimed in claim 1, wherein said one or more of said OSD circuit, said scaler circuit, and said A/D converting circuit, and said DC/DC converting circuit are integrated into a PC graphic card.

4. The extra-monitor control circuit system for monitor as claimed in any one of claims 1, 2, and 3, wherein said extra-monitor control circuit system is electrically connected to said monitor via one or more signal cables and connectors thereof for transmitting signals and power to said monitor from said PC host.
